(19) United States
(12) Patent Application Publication
(10) Pub. No.: US 2018/0045674 A1
(43) Pub. Date: Feb. 15, 2018

(54) A COMPUTER DEVICE FOR ACTING AS A METER

(71) Applicant: CamLab Limited, Cambridge (GB)

(72) Inventors: Rowan David Maulder, Cambridge (GB); David Paul MILLER, Cambridge (GB); Gregory Mark THOMAS, Duxford Cambridgeshire (GB); Matthew John SIMS, Duxford Cambridgeshire (GB); Stephen Charles SIMS, Duxford Cambridgeshire (GB)

(21) Appl. No.: 15/551,380

(22) PCT Filed: Feb. 12, 2016
(86) PCT No.: PCT/EP2016/053074

§ 371 Date: Aug. 16, 2017

(30) Foreign Application Priority Data
Feb. 16, 2015 (GB) 1502569.5

(51) Int. Cl. G01N 27/416

(52) U.S. Cl. CPC G01N 27/4163; G01K 1/00

(57) ABSTRACT

A computer device in the form of a smart phone for acting as a meter comprises a sensor input for inputting data from a sensor, a store, and a data output. The computer device is arranged to act as a meter to provide measurements data from a sensor input at the sensor input over time. The store is arranged to store the measurements and to store measurement configuration data. The computer device is arranged to configure the measurements based on the configuration data to form configured data and to output the configured data from the data output. The computer device also comprises an information input for inputting information that affects the data from the sensor in the form of a camera. The computer device is arranged such that the measurements are associated with the information input at the camera.

### FIELD OF THE INVENTION

The present invention relates to a computer device for acting as a meter.

### BACKGROUND OF THE INVENTION

Electric sensors are well known in the measurement and instrumentation industry. They are used widely in laboratories and in the field to measure physical and chemical properties of samples. A typical electric sensor is an electrochemical sensor such as pH, ion-selective, dissolved oxygen or conductivity electrode or a temperature sensor. They are available commercially in several different form factors.

Electrochemistry and related ion analysis technologies are heavily used in industries. Laboratory-scale electrochemistry instruments are found in nearly all scientific laboratories across the globe. Having the right ion concentration (e.g. pH), is fundamental to all laboratories and serves as the foundation for solvents and reagents.

Reduction potential (also known as redox potential, oxidation/reduction potential, ORP, pE, ε, or Eₕ) is a measure of the tendency of a chemical species to acquire electrons and thereby be reduced. Reduction potential is measured in volts (V), or millivolts (mV). Each species has its own intrinsic reduction potential; the more positive the potential, the greater the species' affinity for electrons and tendency to be reduced. ORP is a common measurement for water quality.

As mentioned above, typically, voltages in the order of millivolts are output from these electric sensors and these voltages are interpreted by a meter to provide units relative to the physical or chemical process being measured. The meter makes a unit conversion from voltage to the relevant unit, such as pH or temperature. To enable this, the meters are generally cleaned or calibrated by placing the probe or sensor into a solution (a calibration standard or calibration solution), and often several different washing solutions or chemical reagents with known chemical properties.

A meter may have both an electrochemical sensor and an electronic temperature sensor fitted to it. This is because the parameters being measured by the electrochemical sensor may be altered by the temperature of a solution under test and so both parameters need to be measured for an accurate electrochemical sensor reading. Temperature sensors may be resistive such as a thermistor, RTD (resistance temperature detector) or PRT (platinum resistance thermometer) or actively producing current with respect to a temperature differential across them such as a thermocouple.

Four examples of electrochemical meters are continuous or on line process pH/ORP and ion selective electrode ISE meters, bench mounted (bench-top) meters, handheld (portable) meters and automated or robotic systems.

Process or on-line meters are often used in industrial applications. They have sensors (probes) mounted in-situ so that they remain immersed in a solution to provide continuous transmission of a signal either by wire or wireless (wifi) to a receiver box or meter and converted to an analogue or digital output to a computer with data analysis software for continuous time stamped monitoring. One example of this type of system is the Z-series from Omega Engineering, Inc. of Stamford, Conn., United States.

Bench mounted meters are designed to be left in a fixed place and connected by cables to the relevant sensor.

Handheld meters often have an electric sensor permanently attached to them via a connector, or a cable and connector assembly. Such meters are typically made using bespoke hardware.

Automated or robotic systems used in laboratories typically uses an XYZ (Cartesian co-ordinate) robotic arm to move sensors from one set of samples to another, or use a moving platform to bring a set of samples to a corresponding set of electrochemical sensors that is in a fixed position. All of the electrochemical sensors are wired into a meter or display which is connected to a computer and information management system. These systems are designed for high throughput sample processing. One example of this type of system is the MANTECH AssayPlus pH System of Mandel, Guelph, Ontario, Canada.

Typically, these meters will have a display or output of some type. These displays or outputs may be a digital number or other digital indicator such as a light emitting diode (LED) display, an analogue display using a moving coil d'Arsonval meter or some type of audible output.

These types of meter may have provision for a digital output of the values being read to a computing device or remote display through an interface such as a wired RS-232 or USB (Universal Serial Bus) connection or wirelessly using Bluetooth (registered trade mark) or IrDA (Infrared Data Association—a wireless infrared communications protocol).

Handheld meters less often have a digital output suitable for reception by a computing device than a bench mounted meter due to the context in which they are intended to be used. A digital output designed for reception by an external computing device creates the possibility of logging the output of the sensor with respect to time. However, this requires the computing device to be connected to the meter at all times which may be inconvenient if the sensor and meter is located in an environment that is hostile to such computing devices.

The presence of cables, even in a fixed location benchtop meter such as may be found in a laboratory, can be a significant inconvenience or indeed safety hazard when dealing with chemicals. They may even preclude the measurement of chemical attributes in some situations. For example, this may be due to the requirement to route the cables from the vessel that a chemical is contained in, to the meter that is situated outside the container. Alternatively, this may be due to the requirement to situate the meter far from the sensor, as might be the case when measuring water in a river from a bridge so that the integrity of the sensor output may be impaired.

Each meter has a physical and electronic termination for the sensor output. For this reason, most meters only have the capability to connect to a single sensor at a time, meaning that many meters are required to measure multiple attributes of even a single experiment. These multiple meters might then have to have logging performed simultaneously, either manually, by one or more operators, or digitally, by one or more computing devices.

The advantage of using wires to connect a sensor to a meter (as opposed to a wireless connection, for example, using Bluetooth (registered trade mark)) is that the physical cable makes it reasonably clear which sensor is connected to which meter. Identifying which sensor is supplying data to which meter is less clear when there is a wireless connection. Often the same meter is used interchangeably for various sensors and it is easy for users to make mistakes in which sensor the meter is taking readings from, particularly with wireless meters.

Wireless meters that attach to electrochemical sensors are known that in some way use the Bluetooth (registered trade mark) wireless communications protocol.

One arrangement is described in US patent application with publication US2008/0041721 (granted as U.S. Pat. No. 7,719,427). This document describes a wireless pH measurement system having a portable module including a signal detecting and processing portion comprising a sensor unit for detecting a pH signal, amplifying, filtering noise, analog/digital conversion and numerical processing to generate a pH measurement signal. The system also includes a wireless transmission portion that transmits the pH measurement by a Bluetooth (registered trade mark) module. The system also includes a receiver end that comprises a Bluetooth (registered trade mark) receiver for receiving the pH measurement signal and amongst other things, displaying the pH measurement, and the receiver end also processes this signal and transmits a warning when an abnormal pH measurement signal is received.

The pHit (trade mark) of Senova Systems, Inc., Sunnyvale, Calif., United States is a handheld pH meter with a non-calibrating solid state sensor and a Bluetooth (registered trade mark) dongle. The signal from the sensor is processed by electronics in the handheld meter and can then be transmitted to a local display or to a PC, tablet computer, or process controller via the Bluetooth (registered trade mark) dongle.

The Myron L (registered trade mark) PTBT1 (pH) and PTBT2 (conductivity) of the Myron L Company, Carlsbad, Calif., United States are “pen-type” meters with a Bluetooth Smart (registered trade mark) transceiver that transmits measurements to any paired mobile device where the readings are displayed. The mobile device acts as the display for the meter effectively replacing the display that is normally integral with a “pen-type” meter.

Laboratory information management systems (LIMSs) (sometimes referred to as Laboratory Information Systems (LISs) or Laboratory Management Systems (LMSs)) are broadly described as software-based systems that offer a set of key features that support a modern laboratory's operations. These key features include, for example, workflow and data tracking support, which means that they can be used in regulated environments. It is important that data in a LIMS is verifiable.

Specifically, amongst other things, LIMSs can be used to store sensor data read by meters. Amongst other things, LIMSs are intended to improve the reliability or quality of scientific data by more reliably recording sensor data read by meters. There are many different LIMSs and each require sensor data to be input into them in a particular format or formats, such as CSV (comma separated values), tab delimited or in Microsoft Excel spreadsheet. A stream of a number of data fields will be defined (by the end user customer) to be input into a LIMS in a specific format.

Sensor data is typically entered into a LIMS by simply typing it into the LIMS or by using a so-called Linking program such as Links for LIMS of CSols Ltd, Runcorn, Cheshire, United Kingdom. Typing the data into a LIMS is very time consuming and it is easy for people to make mistakes. Linking programs are only as reliable as the data entered into them, for example, in properly indicating that the format or configuration of the data to be re-configured; it is easy for a user to improperly describe the format of the source data resulting in an erroneous data conversion or reconfiguration.

As described above, electrochemical sensors usually require a calibration procedure to be performed before the accuracy of their values can be assured. This involves taking a reading from a sensor in known value or calibration standard solution and then applying the resulting calculated adjustment to all subsequent readings of solutions under test. This is usually performed manually by telling the digital meter to regard the currently sensed value as being at a known value. This manual operation can be subject to human error if the wrong calibration standard solution is used or the calibration standard solution is inaccurate or degraded due to expiration.

### BRIEF SUMMARY OF THE INVENTION

Broadly, embodiments of the present invention provide for reliable recording of scientific electric sensor measurements.

The inventors of the present patent application have appreciated that by using a computer device, such a smart phone, with an input, such as Bluetooth receiver, to receive data from a sensor of the type described above over time, and with suitable software to act as meter that, by using typical storage and processing hardware of the smart phone, and special software, that this data or sensor measurements can be readily configured to a suitable format for a plurality of LIMSs. The inventors have appreciated that the LIMS-compatible configured data or sensor measurements can be readily sent from the smart phone (or other computer device) to a remote server, typically a cloud computing arrangement, for access by the LIMS, which is remote from the server itself.

By configuring the data effectively at source, there is less opportunity for errors to be introduced into the description of the format or configuration of the data and, in this way, the scientific data can be more reliably recorded. By exporting or sending the data to the remote server allows for ready communication between the smartphone (or other computer device) acting as a meter and the LIMS.

The inventors of the present patent application have appreciated that by using the standard hardware features of a smartphone and special software that the smartphone (or other computer device or general purpose computer) can act as a meter and to reconfigure data from the meter to provide very reliable data input into a LIMS.

The inventors of the present patent application have appreciated that by using a standard input or sensor such as a camera of a computer device, such as a smart phone, to read an identifier or identifiers (such as a two dimensional or matrix barcode, for example, a QR code) on a sensor, data storage or data transmission device or cap of a sensor, or a calibration solution used to calibrate the sensor when the device also acts as a meter for the sensor using special software installed on it, that the data reading or measurement is tied with the particular item or items associated with the identifier thus providing a closed quality loop and reliable data measurement. The inventors of the present application have also appreciated that the information from the identifiers can advantageously be used in other ways, for example, to indicate a possible problem with the item associated with the identifier or identifiers scanned such as that the calibration solution or sensor is so old that it may have degraded or to know which cap (sensor interface) or sensor a measurement from the meter originates. The latter feature is particularly important for a computer device acting as a meter for a plurality of caps or sensors as it makes it clear which cap or sensor a measurement from the meter originates.

The inventors of the present patent application have appreciated that this computer device or smart phone may act as a meter either individually or severally for a plurality of different sensors. This provides a low cost and space saving arrangement, for example, by saving bench space.

The invention in its various aspects is defined in the independent claims below to which reference should now be made. Advantageous features are set forth in the dependent claims.

Arrangements are described in more detail below and take the form of a computer device in the form of a smart phone for acting as a meter comprising a sensor input for inputting data from a sensor, a store, and a data output. The computer device is arranged to act as a meter to provide measurements based on data from a sensor input at the sensor input over time. The store is arranged to store the measurements and to store measurement configuration data. The computer device is arranged to configure the measurements based on the configuration data to form configured data and to output the configured data from the data output. The computer device also comprises an information input for inputting information that affects the data from the sensor in the form of a camera. The computer device is arranged such that the measurements are associated with the information input at the camera.

In an aspect of the present invention, there is provided a computer device for acting as a meter, the computer device comprising: a sensor input for inputting data from a sensor, a store, and a data output; the computer device being arranged to act as a meter to provide measurements based on data from a sensor input at the sensor input over time; the store being arranged to store the measurements and to store measurement configuration data; the computer device being arranged to configure the measurements based on the configuration data to form configured data and to output the configured data from the data output.

The computer device may be arranged to output the configured data from the data output to a cloud computing arrangement.

The computer device may comprise a portable computer device, such as a smart phone or wearable computer, a laptop computer or a tablet computer. The computer device may be a general purpose computing device.

The measurement configuration data may comprise configuration data for a plurality of laboratory information management systems.

The data from the sensor may be stored in a store associated with the sensor before inputting at the input.

In another aspect of the invention, there is provided a computerized method comprising: providing measurements based on a sensor input over time; storing the measurements and measurement configuration data; configuring the measurements based on the configuration data to form configured data; and outputting the configured data.

In another aspect of the present invention, there is provided a computer device for acting as a meter, the computer device comprising: a sensor input for inputting data from a sensor, and an information input for inputting information that affects the data from the sensor; the computer device being arranged to: act as a meter to provide measurements based on the sensor input; wherein the measurements are associated with the information that is input at the information input.

The information input may be for at least one image. The information input may be for machine-readable information. The machine readable information may comprise a bar code, such as a two-dimensional bar code.

The information input may comprise a camera.

The computer device may be arranged to output the information that affects the data from the sensor. The computer device may be arranged to output the information that affects the data from the sensor to a cloud computing arrangement.

The information that affects the data from the sensor may comprise one or more of: information regarding the sensor; information regarding a sensor interface that stores data from the sensor and transmits the data from the sensor to the computer device; information regarding a calibration solution for the sensor; information regarding a reagent for the sensor. The information regarding the sensor may comprise a date associated with the sensor. The computer device may be arranged to provide an indication that the sensor has degraded in response to the information regarding the sensor. The information regarding a sensor interface that stores data from the sensor and transmits the data from the sensor to the computer device may comprise an identifier of the sensor interface. The information regarding a calibration solution may comprise a date associated with the calibration solution. The information regarding a reagent may comprise a date associated with the calibration solution.

The computer device may be arranged to provide access to a website, an e-commerce system and/or a database in response to the information that affects the data from the sensor.

In another aspect of the present invention, there is provided a computerized method comprising: a computer device acting as a meter by providing measurements based on a sensor input over time; and associating the measurements with information that is input at an information input of the computer device.

In another aspect of the present invention, there is provided a computer device for acting as a meter, the computer device being a general purpose computer device and comprising: a sensor input for inputting data from a plurality of sensors, wherein the computer device is arranged to act as a meter to provide measurements based on data from the plurality of sensors, input at the sensor input, over time; and wherein the sensors are at least one of: electrochemical sensors or temperature sensors.

The computer device may be configured to select the sensor from the plurality of sensors for which its acts as a meter. The computer device may be configured to select the sensor based on user input. The computer device may be configured to automatically select the sensor based on input from the sensor. The computer device may be configured to select the sensor based on information that is input at an information input of the computer device. The information input may be for at least one image. The information input may be for machine-readable information. The machine readable information may comprise a bar code, such as a two-dimensional bar code. The information input may comprise a camera. The image may include a photograph of calibration solution and reagent; this is not a scanned image.

In another aspect of the present invention, there is provided a computerized method comprising: a general purpose computer device acting as a meter for a plurality of sensors by providing measurements based on a plurality of sensors input at a sensor input of the computer device over time; wherein the sensors are at least one of: electrochemical sensors or temperature sensors.

In an example, each sensor has a unique identifier. In the example, each sensor has a cap or sensor interface, typically at one end, that collects data. Data can be continuously logged and stored on the sensor. This data is sent from the cap to the general purpose computer on which special software or an application is installed. The data collected by the cap is sent by wireless or radio transmission such as by Bluetooth (registered trade mark) at set intervals or when in proximity to make a connection to the computer. The data also includes a unique identifier signal this may be used to provide information on, for example, the sensor type, shelf life, last calibration, and the parameter it is measuring (such as, ion selective or hydrogen or dissolved oxygen or conductivity). Alternatively, the sensor and associated information may be established from a physical barcode on the sensor that is read by the computer device.

In this way, a single screen of the computer device may act as a combined display of multiple sensors. Independent calibration can be performed with different reagents and buffers for each sensor. Data from the sensor may be stored on the computer device or readily transferred, for example, for analysis by special analysis software of the end user. The computer device may be compact or small such as a smart phone. One or more of geo positioning, clock stamp, password protection, level of authority setting, finger print identification may also be readily provided for so-called “Good laboratory practice” (GLP) and “Good manufacturing practice” (GMP) as these features are readily provided by general purpose computer devices such as smart phones.

An example computer device provides multipoint measurement of a process flow or a time based experiment and can provide good workflow. Multiple different types of measurement can be made at the same time.

Data from the plurality of sensors may be displayed at the same time on one page. The data may be displayed graphically, statistically, or numerically and in real time or continuous mode.

A computer program may be provided for implementing the computerized methods described above.

A computer readable medium containing a set of instructions that causes a computer to perform the computerized methods described above may be provided.

### BRIEF DESCRIPTION OF THE DRAWINGS

The invention will be described in more detail, by way of example, with reference to the accompanying drawings, in which:

FIG. 1 is a schematic diagram including a computer system including a computer device embodying an aspect of the present invention; and

FIG. 2 is a schematic diagram including a computer device embodying an aspect of the present invention.

### DETAILED DESCRIPTION OF THE INVENTION

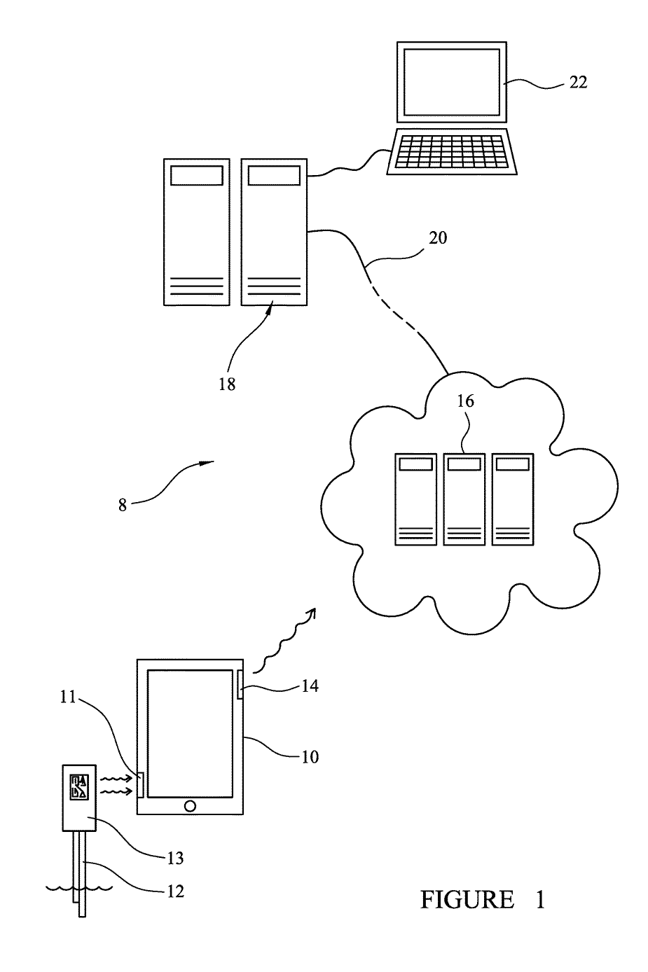

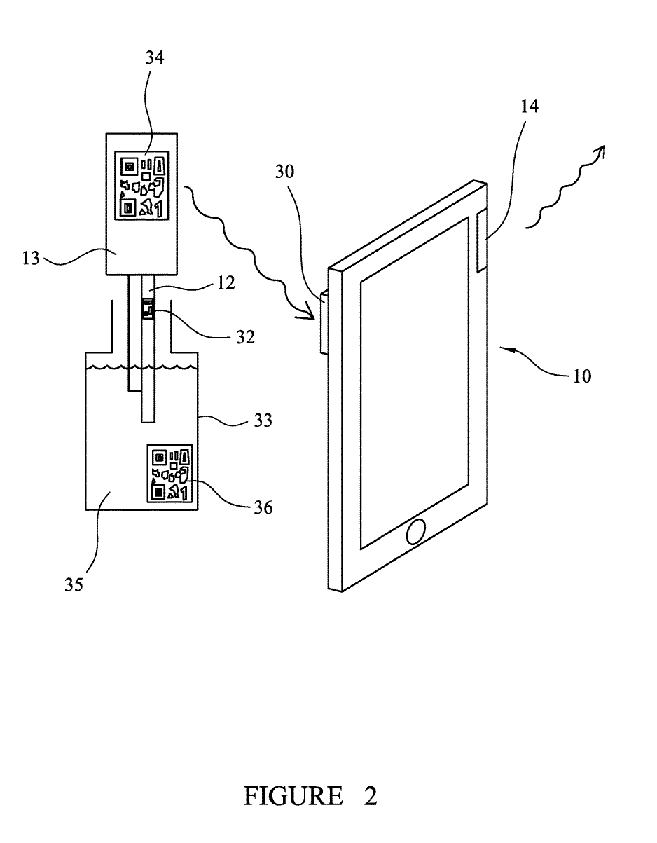

An example computer system 8 including a computer device in the form of a general purpose computer device, in this example, a smart phone 10 will now be described with reference to FIGS. 1 and 2.

As illustrated in FIG. 1, the general purpose computer device or smart phone 10, such as an Apple iPhone, has an input 11 for inputting data from a sensor 11, in this example, in the form of a Bluetooth transceiver that receives information or data in the form of a signal representing voltage (typically in the order of millivolts) from a sensor 12. The smart phone has special software, a computer program or an app or application installed on it so that it acts as a meter to provide measurements based on the sensor input over time. In this way, it converts the signal to an indication of the intended parameter to be measured by the sensor, such as temperature and/or pH. The smart phone includes a store or memory (not shown), in this example, solid state memory to store these parameters periodically over time. Other parameters are also stored, such as, an identifier for the sensor, time of each reading, and date of each reading. These parameters are stored in a predetermined format. The smart phone also stores measurement configuration data. That is, a plurality of different data formats that can be interpreted by different LIMSs. The smart phone configures the measurements based on the configuration data to form configured data. The configured data is output from a data output of the smart phone, for example, via a WiFi transceiver 14 and then over the Internet to a cloud computing arrangement 16. A LIMS 18 accesses this configured data via the Internet 20 for viewing and analysis via a computer terminal 22 of the LIMS.

As explained above, by configuring the data in this way at source, there is less opportunity for errors to be introduced into the description of the format or configuration of the data and, in this way, the scientific data can be more reliably recorded. By exporting or sending the data to the remote server or cloud computing arrangement 16 allows for ready communication between the smart phone 10 acting as a meter and the LIMS 18.

In this example, the sensor has a sensor interface or cap 13 that includes a store or memory that stores data from the sensor or probe 12 over a period of time. In this example, the cap is located and fixed to a distal end of the sensor, but it could be associated with the sensor in other ways. The data from the sensor stored in the cap is periodically input at the input 11 of the smart phone 10. In this example, the cap transmits the stored sensor data to the input of the smart phone on receipt at the cap of an appropriate signal from the smart phone such as via a Bluetooth (registered trade mark) or other radio signal.

A single smart phone may act as a meter for a plurality of sensors. In which case, data from the plurality of sensors is input at input 11. It is significant that a single smart phone may act as a meter for a plurality of sensors as this avoids the need for plural different meters, one for each sensor.

As illustrated in FIG. 2, the smart phone 10 has an information input for inputting information that affects the data from the sensor in the form of an image sensor or camera 30. Also shown in FIG. 2, is the sensor 12 of FIG. 1 including cap 13 at the sensor's distal end as well as a container 33 with a calibration solution 35 inside it.

The sensor includes machine readable information in the form of a bar code and in particular a two-dimensional bar code in the form of a QR code 32 (a QR code is a format for encoding alphanumeric or binary data within a 2-dimensional printable image). The cap includes machine readable information in the form of a bar code and in particular a two-dimensional bar code in the form of a QR code 34. The container 33 with the calibration standard solution 35 includes machine readable information in the form of a bar code and in particular a two-dimensional bar code in the form of a QR code 36.

The camera takes an image of the QR code or codes and the special software, computer program or app installed on the smart phone interprets the image to provide information regarding the item to which the scanned or imaged QR code is attached.

This is achieved by the smart phone decoding the QR code to provide information that affects the data from the sensor, such as an indication of the cap connected, sensor(s) used, reagents and/or calibration standards used. This information is stored on the store of the smart phone. The information is transmitted to the cloud computing arrangement 16 (shown in FIG. 1) via a WiFi transceiver 14 of the smart phone as the identifier for the sensor.

Thus, the measurements from the sensor 12 via cap 13 and with particular calibration solution or solutions are associated with the information input at the camera 30. As explained above, in this way, the data reading or measurement is tied with the particular cap, calibrations standards and sensor(s) 12 thus providing a closed quality loop and reliable data measurement.

As an alternative to or in addition to, the camera of the smart phone may take an image or photo of the relevant item such as the cap connected, sensor(s) used, reagents and/or calibration standards label (the identification of the written label on the product with expiry date) used and this provides verification of the information that affects the data from the sensor.

As explained above, the computer device or smart phone 10 having a camera 30 and software to recognise and parse QR codes is able to scan a QR code on the packaging of calibration standard or calibration solution (a solution to calibrate a sensor with known properties). Special software on the smart phone determines or interprets the actual value of the calibration solution (for example, its pH) and the date of its manufacture to use within the calibration calculation; a table or graph (a calibration standard graph) is used to advise the user through the computer device that the calibration solution should not be used for calibration; or that the wrong calibration solution is about to be used. Such information is critical in verifying that mandated procedures for calibration are being used by the operator meet quality or compliance protocols, for example, Good laboratory practice (GLP), Good manufacturing practice (GMP) and legislation of the appropriate environment protection agency. If particular instances of reagents or calibration solutions are identified then an audit trail may be built on the computing device 10 (or from the cloud computing arrangement using the LIMS 18) for verifying compliance to appropriate quality standards and for audit trail analysis in the case that something has gone wrong. Thus, calibration data is provided by the smart phone as a part of the verifications system and chain of evidential proof for external legal and quality verification.

Additionally, in this example, the QR code 32 of the sensor 12 has encoded on it the type and parameters of the sensor. The smart phone 10 includes a special software application to read and interpret this QR code so that values or data produced by the sensor may be processed differently or in a particular way; or the sensor may be driven or controlled electrically in suitable ways dependent on the QR code. A date of manufacture of the sensor may be encoded in the QR code and the special software of the smart phone 10 may be configured to alert a user that a sensor may not function as expected due to degradation over time. A new instance of a sensor to the system (smart phone 10 or cloud computing arrangement 16) may be regarded as having its expiration timer started and the timestamp recorded so that the mobile software application on the smart phone or server software application in the cloud can alert the user when a replacement should be considered to compensate for degradation in performance due to age.

Alerts regarding possible problems with the calibration solution or sensor 12 may trigger an action in the smart phone 10 that allows the user to buy new calibration solution or a sensor respectively or a replacement battery for the sensor or its cap 13 over the Internet through an e-commerce system externally located to the system 8. Alternatively, or additionally, the action may be to provide access to a website and/or a database containing information about the problem.

In summary, a sensor to the system (smart phone 10 or cloud computing arrangement 16) may have its expiration timer started and the timestamp recorded so that the mobile software application on the smart phone or server software application in the cloud can alert the user when a replacement should be considered to compensate for degradation in performance due to age. Alerts regarding possible problems with the calibration solution or sensor 12 may trigger an action in the smart phone 10 that allows the user to buy new buffer solution or a sensor respectively over the Internet through an e-commerce system externally located to the system 8.

Alternatively or additionally, the general purpose computer device or smart phone 10 may act as a meter to provide measurements based on data from a plurality of different sensors, input at the sensor input or Bluetooth transceiver 11 of the smart phone, over time. In which case, the computer device can select the sensor from the plurality of sensors for which it acts as a meter. For example, the selection may be made by user input by a user selecting a particular representation of a button on the screen of the smart phone. The computer device may automatically select the sensor based on input from the sensor, such as an identifier of the sensor, received at the Bluetooth transceiver. In which case, the sensor 12 can transmit an indication of its identity via Bluetooth. The computer device may select the sensor 12 based on information that is input at an information input, such as at least one image taken by camera 30, of the computer device. This may be the machine-readable information in the form of a bar code, such as a two-dimensional bar code or QR code 32 of the type described above that identifies a particular sensor. The computer device may act as a single meter for a plurality of individual sensors attached to a single Bluetooth Low Energy cap or sensor interface 13 described above. Electric sensors or sensors described above may be, for example, an electrochemical sensor such as pH, ion-selective, dissolved oxygen or conductivity electrode; or a temperature sensor or other sensor for measuring physical and chemical properties of samples. More than one sensor may be provided in one housing.

While the computer device is described as a smart phone, it may be another portable computer device or general purpose computing device, such as a laptop computer or a tablet computer or a wearable computer, for example a smart watch or computerized wristwatch.

The computerized method described above may be implemented as a computer program and provided on a computer readable medium, such a CD-ROM, DVD-ROM or solid state storage device such as USB stick, containing a set of instructions that causes a computer to perform the computerized method.

Embodiments of the present invention have been described. It will be appreciated that variations and modifications may be made to the described embodiments within the scope of the present invention.

1. A computer device for acting as a meter, the computer device comprising:
a sensor input for inputting data from a sensor, a store, and a data output;
the computer device being arranged to act as a meter to provide measurements based on data from a sensor, input at the sensor input, over time;
the store being arranged to store the measurements and to store measurement configuration data;
the computer device being arranged to configure the measurements based on the configuration data to form configured data and to output the configured data from the data output.

2. A computer device according to claim 1, wherein the computer device is arranged to output the configured data from the data output to a cloud computing arrangement.

3. A computer device according to claim 1 or claim 2, wherein the computer device comprises a portable computer device, such as a smart phone or wearable computer, a laptop computer or a tablet computer.

4. A computer device according to any preceding claim, wherein the measurement configuration data comprises configuration data for a plurality of laboratory information management systems.

5. A computer device according to any preceding claim, wherein the data from the sensor is stored in a store associated with the sensor before inputting at the input.

6. A computerized method comprising:
providing measurements based on a sensor input over time;
storing the measurements and measurement configuration data;
configuring the measurements based on the configuration data to form configured data; and
outputting the configured data.

7. A computerized method according to claim 6, further comprising outputting the configured data to a cloud computing arrangement.

8. A computerized method according to claim 6 or claim 7, wherein the method is carried out on a portable computer device, such as a smart phone or a wearable computer, a laptop computer or a tablet computer.

9. A computerized method according to any of claims 6 to 8, further comprising storing the data from the sensor in a store associated with the sensor before providing the measurements.

10. A computer device for acting as a meter, the computer device comprising:
a sensor input for inputting data from a sensor, and an information input for inputting information that affects the data from the sensor;
the computer device being arranged to:
act as a meter to provide measurements based on the sensor input; wherein the measurements are associated with the information that is input at the information input.

11. A computer device according to claim 10, wherein the information input is for at least one image.

12. A computer device according to claim 10 or claim 11, wherein the information input is for machine-readable information.

13. A computer device according to claim 12, wherein the machine readable information comprises a bar code, such as a two-dimensional bar code.

14. A computer device according to any of claims 10 to 13, wherein the information input comprises a camera.

15. A computer device according to any of claims 10 to 14, wherein the computer device is arranged to output the information that affects the data from the sensor.

16. A computer device according to claim 15, wherein the computer device is arranged to output the information that affects the data from the sensor to a cloud computing arrangement.

17. A computer device according to any of claims 10 to 16, wherein the information that affects the data from the sensor comprises one or more of:
information regarding the sensor;
information regarding a sensor interface that stores data from the sensor and transmits the data from the sensor to the computer device;
information regarding a calibration solution for the sensor;
information regarding a reagent for the sensor.

18. A computer device according to claim 17, wherein the information regarding the sensor comprises a date associated with the sensor.

19. A computer device according to claim 17 or claim 18, wherein the computer device is arranged to provide an indication that the sensor has degraded in response to the information regarding the sensor.

20. A computer device according to any of claims 17 to 19, wherein the information regarding a sensor interface that stores data from the sensor and transmits the data from the sensor to the computer device comprises an identifier of the sensor interface.

21. A computer device according to any of claims 17 to 20, wherein the information regarding a calibration solution comprises a date associated with the calibration solution.

22. A computer device according to any of claims 17 to 21, wherein the computer device is arranged to provide access to a website, an e-commerce system and/or a database in response to the information that affects the data from the sensor.

23. A computerized method comprising:
a computer device acting as a meter by providing measurements based on a sensor input over time; and
associating the measurements with information that is input at an information input of the computer device.

24. A computerized method according to claim 23, wherein the information input is for at least one image.

25. A computerized method according to claim 23 or claim 24, wherein the information input is for machine-readable information.

26. A computerized method according to claim 25, wherein the machine readable information comprises a bar code, such as a two-dimensional bar code.

27. A computerized method according to any of claims 23 to 26, wherein the information input comprises a camera.

28. A computerized method according to any of claims 23 to 27, further comprising the computer device outputting the information that affects the data from the sensor.

29. A computerized method according to claim 28, further comprising the computer device outputting the information that affects the data from the sensor to a cloud computing arrangement.

30. A computerized method according to any of claims 23 to 29, wherein the information that affects the data from the sensor comprises one or more of:
information regarding the sensor;
information regarding a sensor interface that stores data from the sensor and transmits the data from the sensor to the computer device;
information regarding a calibration solution for the sensor;
information regarding a reagent for the sensor.

31. A computerized method according to claim 30, wherein the information regarding the sensor comprises a date associated with the sensor.

32. A computerized method according to claim 30 or claim 31, further comprising the computer device providing an indication that the sensor has degraded in response to the information regarding the sensor.

33. A computerized method according to any of claims 30 to 32, wherein the information regarding a sensor interface that stores data from the sensor and transmits the data from the sensor to the computer device comprises an identifier of the sensor interface.

34. A computerized method according to any of claims 30 to 33, wherein the information regarding a calibration solution comprises a date associated with the calibration solution.

35. A computerized method according to any of claims 30 to 34, further comprising the computer device providing access to a website, an e-commerce system and/or a database in response to the information that affects the data from the sensor.

36. A computer device comprising:
an information input for inputting information that affects data from a sensor; wherein the computer device is configured to provide an indication in response to the information that is input.

37. A computer device according to claim 36, wherein the computer device is arranged to output the information that affects the data from the sensor.

38. A computer device according to claim 36, wherein the computer device is arranged to output the information that affects the data from the sensor to a cloud computing arrangement.

39. A computer device according to any of claims 36 to 38, wherein the information that affects the data from the sensor comprises one or more of:
information regarding the sensor;
information regarding a sensor interface that stores data from the sensor and transmits the data from the sensor to the computer device;
information regarding a calibration solution for the sensor;
information regarding a reagent for the sensor.

40. A computer device according to claim 39, wherein the information regarding the sensor comprises a date associated with the sensor.

41. A computer device according to claim 39 or claim 40, wherein the computer device is arranged to provide an indication that the sensor has degraded in response to the information regarding the sensor.

42. A computer device according to any of claims 39 to 41, wherein the information regarding a sensor interface that stores data from the sensor and transmits the data from the sensor to the computer device comprises an identifier of the sensor interface.

43. A computer device according to any of claims 39 to 42, wherein the information regarding a calibration solution comprises a date associated with the calibration solution.

44. A computer device according to any of claims 39 to 43, wherein the computer device is arranged to provide access to a website, an e-commerce system and/or a database in response to the information that affects the data from the sensor.

45. A computerized method comprising:
inputting at an information input of a computer device information that affects data from a sensor; and
the computer device providing an indication in response to the information that is input.

46. A computerized method according to claim 45, further comprising the computer device outputting the information that affects the data from the sensor.

47. A computerized method according to claim 45, further comprising the computer device outputting the information that affects the data from the sensor to a cloud computing arrangement.

48. A computerized method according to any of claims 45 to 47, wherein the information that affects the data from the sensor comprises one or more of:
information regarding the sensor;
information regarding a sensor interface that stores data from the sensor and transmits the data from the sensor to the computer device;
information regarding a calibration solution for the sensor;
information regarding a reagent for the sensor.

49. A computerized method according to claim 48, wherein the information regarding the sensor comprises a date associated with the sensor.

50. A computerized method according to claim 48 or claim 49, further comprising the computer device providing an indication that the sensor has degraded in response to the information regarding the sensor.

51. A computerized method according to any of claims 48 to 50, wherein the information regarding a sensor interface that stores data from the sensor and transmits the data from the sensor to the computer device comprises an identifier of the sensor interface.

52. A computerized method according to any of claims 48 to 51, wherein the information regarding a calibration solution comprises a date associated with the calibration solution.

53. A computerized method according to any of claims 48 to 52, further comprising the computer device providing access to a website, an e-commerce system and/or a database in response to the information that affects the data from the sensor.

54. A computer device for acting as a meter, the computer device being a general purpose computer device and comprising:
a sensor input for inputting data from a plurality of sensors, wherein the computer device is arranged to act as a meter to provide measurements based on data from the plurality of sensors, input at the sensor input, over time; and wherein the sensors are at least one of: electrochemical sensors or temperature sensors.

55. A computer device according to claim 54, wherein the computer device is configured to select the sensor from the plurality of sensors for which it acts as a meter.

56. A computer device according to claim 55, wherein the computer device is configured to select the sensor based on user input.

57. A computer device according to claim 55, wherein the computer device is configured to automatically select the sensor based on input from the sensor.

58. A computer device according to claim 55, wherein the computer device is configured to select the sensor based on information that is input at an information input of the computer device.

59. A computer device according to claim 58, wherein the information input is for at least one image.

60. A computer device according to claim 58 or claim 59, wherein the information input is for machine-readable information.

61. A computer device according to claim 60, wherein the machine readable information comprises a bar code, such as a two-dimensional bar code.

62. A computer device according to any of claims 58 to 61, wherein the information input comprises a camera.

63. A computerized method comprising:
a general purpose computer device acting as a meter for a plurality of sensors by providing measurements based on a plurality of sensors input at a sensor input of the computer device over time; wherein the sensors are at least one of: electrochemical sensors or temperature sensors.

64. A computerized method according to claim 63, wherein the method further comprises the computer device selecting the sensor from the plurality of sensors for which its acts as a meter.

65. A computerized method according to claim 64, wherein the method further comprises the computer device selecting the sensor based on user input.

66. A computerized method according to claim 64, wherein the method further comprises the computer device automatically selecting the sensor based on input from the sensor.

67. A computerized method according to claim 64, wherein the method further comprises the computer device selecting the sensor based on information that is input at an information input of the computer device.

68. A computerized method according to claim 67, wherein the information input is for at least one image.

69. A computerized method according to claim 67 or claim 68, wherein the information input is for machine-readable information.

70. A computerized method according to claim 69, wherein the machine-readable information comprises a bar code, such as a two-dimensional bar code.

71. A computerized method according to any of claims 67 to 70, wherein the information input comprises a camera.

72. A computer program for implementing the computerized method of any of claims 6 to 9, 23 to 35, 45 to 53 or 63 to 71.

73. A computer readable medium containing a set of instructions that causes a computer to perform the computerized method of any of claims 6 to 9, 23 to 35, 45 to 53 or 63 to 71.
